(19) United States
(12) Patent Application Publication
(10) Pub. No.: US 2010/0110398 A1
(43) Pub. Date: May 6, 2010

(54) METHODS RELATING TO IMMERSION LITHOGRAPHY AND AN IMMERSION LITHOGRAPHIC APPARATUS

(75) Inventors: Roelof Frederik DE GRAAF, Veldhoven (NL); Antonius Johannus Van Der Net, Tilburg (NL); Marco Koert Stavenga, Eindhoven (NL); Johannes Wilhelmus Jacobus Leonardus Cuijpers, Roermond (NL); Martinus Wilhelmus Van Den Heuvel, Best (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 12/429,953

(22) Filed: Apr. 24, 2009

Related U.S. Application Data
(60) Provisional application No. 61/071,390, filed on Apr. 25, 2008.

(51) Int. Cl. G03B 27/52

(52) U.S. Cl. 355/30

(57) ABSTRACT

A method of detecting particles in an immersion fluid of or from a lithographic apparatus. The method includes extracting a sample, using a vacuum system, from a single phase flow of the immersion fluid of or from a fluid handling structure in the lithographic apparatus. The method includes detecting particles in the sample, and initiating a signal if the detected particles are above a certain threshold.

### CROSS-REFERENCE TO RELATED APPLICATIONS

This application claims the benefit of priority from U.S. Provisional Patent Application No. 61/071,390, filed on Apr. 25, 2008, the entire content of which is incorporated herein be reference.

### FIELD

The present invention relates to a method of operating a fluid handling system and an immersion lithographic apparatus.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. comprising part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

It has been proposed to immerse the substrate in the lithographic projection apparatus in a liquid having a relatively high refractive index, e.g. water, so as to fill a space between the final element of the projection system and the substrate. One or more embodiments are described herein in relation to the immersion liquid being water. In an embodiment, the liquid is distilled water. However, one or more embodiments are equally applicable to other types of immersion liquid. Such immersion liquids may have a refractive index greater than that of air. Desirably, the immersion liquid has a refractive index greater than that of water. Although an embodiment of the present invention will be described with reference to liquid, another fluid may be suitable. Fluids that are desirable include wetting fluids, incompressible fluids and/or fluids with higher refractive index than air, desirably a higher refractive index than water. Fluids excluding gases are particularly desired. The point of this is to enable imaging of smaller features since the exposure radiation will have a shorter wavelength in the liquid. (The effect of the liquid may also be regarded as increasing the effective numerical aperture (NA) of the system and also increasing the depth of focus.) Other immersion liquids have been proposed, including water with solid particles (e.g. quartz) suspended therein, or liquids with nano-particle suspensions (e.g. particles with a maximum dimension of up to 10 nm). The suspended particles may or may not have a similar or the same refractive index as the liquid in which they are suspended. Other liquids which may be suitable are hydrocarbons, such as aromatics, fluoro-hydrocarbons, and aqueous solutions.

However, submersing the substrate or substrate and substrate table in a bath of liquid (see, for example, U.S. Pat. No. 4,509,852) means that there is a large body of liquid that should be accelerated during a scanning exposure. This may require additional or more powerful motors and turbulence in the liquid may lead to undesirable and unpredictable effects.

One of the solutions proposed is for a liquid supply system to provide liquid on only a localized area of the substrate and in between the final element of the projection system and the substrate using a liquid confinement structure (the substrate generally has a larger surface area than the final element of the projection system). One way which has been proposed to arrange for this is disclosed in PCT patent application publication no. WO 99/49504. As illustrated in FIGS. 2 and 3, liquid is supplied by at least one inlet IN onto the substrate, desirably along the direction of movement of the substrate relative to the final element, and is removed by at least one outlet OUT after having passed under the projection system. That is, as the substrate is scanned beneath the element in a −X direction, liquid is supplied at the +X side of the element and taken up at the −X side. FIG. 2 shows the arrangement schematically in which liquid is supplied via inlet IN and is taken up on the other side of the element by outlet OUT which is connected to a low pressure source. In the illustration of FIG. 2 the liquid is supplied along the direction of movement of the substrate relative to the final element, though this does not need to be the case. Various orientations and numbers of in- and out-lets positioned around the final element are possible, one example is illustrated in FIG. 3 in which four sets of an inlet with an outlet on either side are provided in a regular pattern around the final element.

In European patent application publication no. EP 1420300 and United States patent application publication no. US 2004-0136494, each hereby incorporated in their entirety by reference, the idea of a twin or dual stage immersion lithography apparatus is disclosed. Such an apparatus is provided with two tables for supporting a substrate. Leveling measurements are carried out with a table at a first position, without immersion liquid, and exposure is carried out with a table at a second position, where immersion liquid is present. Alternatively, the apparatus has only one table.

Many types of immersion lithographic apparatus have in common that immersion fluid is provided to a space between the final element of the projection system and the substrate. That liquid is also usually removed from that space. For example, such removal may be for cleaning of the immersion fluid or for temperature conditioning of the immersion fluid, etc.

### SUMMARY

Immersion lithographic apparatus may get contaminated for example by resist and topcoat residues. The contamination may be more likely to occur during process events, in which coated substrates, especially poorly coated substrates, may be exposed in the apparatus. This may lead to increased defectivity levels for many, if not all, subsequent substrates that are exposed in the apparatus. Without fast detection, many hours of worthless production and cleaning may occur. Current immersion lithographic apparatus appear not to have a mechanism that detects major process excursions, such as exposing badly coated substrates, which may contribute to increased defect rates. Although advanced metrology may be applied to determine yield, such methods may lead to long production runs with high defects (e.g., one day). This is because contamination was not detected soon enough.

It is desirable, for example, to be able to detect when there are particles in the immersion fluid. Particles present in the immersion fluid may contribute to defects in the exposed substrate or may be indicative of defects in the substrate prior to exposure. By detecting such particles earlier in the exposure process, the number of defective exposed substrates may be minimized and the number of defects present on a substrate may be helped to be reduced.

According to an aspect of the invention, there is provided a method of detecting particles in an immersion fluid of or from a lithographic apparatus. The method includes extracting a sample, using a vacuum system, from a single phase flow of the immersion fluid of or from a fluid handling structure in the lithographic apparatus. The method includes detecting particles in the sample, and initiating a signal if the detected particles are above a certain threshold.

According to an aspect of the invention, A method of operating a liquid particle counter for an immersion lithographic apparatus. The immersion lithographic apparatus includes a projection system, a substrate table, and a fluid handling structure. The method includes flowing a sample through the liquid particle counter. The sample includes a first liquid from the fluid handling structure when the fluid handling structure is confining liquid between the projection system and a substrate being supported by the substrate table and/or the substrate table. Alternatively, the sample includes a second liquid from a liquid supply when the fluid handling structure is not confining liquid between the projection system and the substrate being supported by the substrate table and/or substrate table. The method includes detecting particles in the sample.

According to an aspect of the invention, there is provided a lithographic apparatus that includes a substrate support configured to hold a substrate, and a projection system configured to project a patterned beam of radiation onto a target portion of the substrate. The apparatus includes a fluid handling structure configured to supply an immersion fluid to a space between the projection system and the substrate and/or the substrate support, and to extract the immersion fluid from the space through an opening of the fluid handling structure. The apparatus includes a vacuum system configured to extract a sample of the immersion fluid from the opening, and a particle counter located between the vacuum system and the opening. The particle counter is configured to detect particles in the sample of the immersion fluid.

According to an aspect of the invention, there is provided a lithographic apparatus that includes a substrate support configured to hold a substrate, and a projection system configured to project a patterned beam of radiation onto a target portion of the substrate. The apparatus includes a fluid handling structure configured to supply an immersion fluid to a space between the projection system and the substrate and/or the substrate support, and an opening through which the immersion fluid is extracted from the space. The apparatus includes a particle counter connected to the opening. The particle counter is configured to detect particles in a sample provided to the particle counter. The apparatus includes a liquid supply configured to supply a liquid to the particle counter when a flow of the immersion fluid is below a certain threshold value.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 illustrates a lithographic apparatus according to an embodiment of the invention;

FIGS. 2 and 3 illustrate embodiments of a fluid handling structure for use in the lithographic apparatus of FIG. 1;

FIG. 4 illustrates an embodiment of a fluid handling structure for use in the lithographic apparatus of FIG. 1;

FIG. 5 illustrates an embodiment of a fluid handling structure for use in the lithographic apparatus of FIG. 1;

FIGS. 6a, 6b, and 6c illustrate an embodiment of a fluid handling structure for use in the lithographic apparatus of FIG. 1;

FIG. 7 illustrates an embodiment of a fluid handling structure for use in the lithographic apparatus of FIG. 1;

FIG. 8 schematically illustrates an embodiment of a particle detection system for use in the lithographic apparatus of FIG. 1;

FIG. 9 is a schematic diagram of a portion of a fluid handling structure of the lithographic apparatus of FIG. 1;

FIG. 10 schematically illustrates an embodiment of a liquid particle counter of the particle detection system of FIG. 8;

FIG. 11 illustrates a typical calibration curve for the liquid particle counter of FIG. 10; and

FIG. 12 schematically illustrates an embodiment of a particle detection system for use in the lithographic apparatus of FIG. 1.

### DETAILED DESCRIPTION

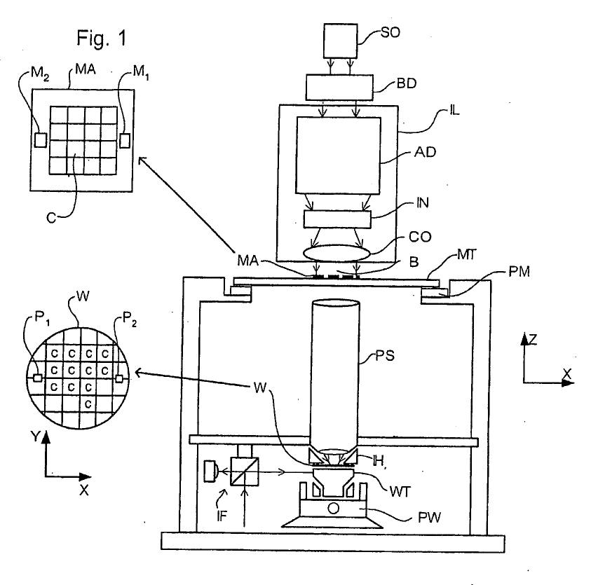

FIG. 1 schematically depicts a lithographic apparatus according to one embodiment of the invention. The apparatus comprises an illumination system (illuminator) IL configured to condition a radiation beam B (e.g. UV radiation or DUV radiation); a support structure (e.g. a mask table) MT constructed to support a patterning device (e.g. a mask) MA and connected to a first positioner PM configured to accurately position the patterning device in accordance with certain parameters; a substrate table (e.g. a wafer table) WT constructed to hold a substrate (e.g. a resist-coated wafer) W and connected to a second positioner PW configured to accurately position the substrate in accordance with certain parameters; and a projection system (e.g. a refractive projection lens system) PS configured to project a pattern imparted to the radiation beam B by patterning device MA onto a target portion C (e.g. comprising one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure holds the patterning device in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g. employing a transmissive mask). Alternatively, the apparatus may be of a reflective type (e.g. employing a programmable mirror array of a type as referred to above, or employing a reflective mask).

The lithographic apparatus may be of a type having two (dual stage) or more substrate tables (and/or two or more patterning device support structures). In such “multiple stage” machines the additional tables and/or support structures may be used in parallel, or preparatory steps may be carried out on one or more tables and/or support structures while one or more other tables and/or support structures are being used for exposure.

Referring to FIG. 1, the illuminator IL receives a radiation beam from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD to adjust the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. Having traversed the patterning device MA, the radiation beam B passes through the projection system PS, which focuses the beam onto a target portion C of the substrate W. With the aid of the second positioner PW and position sensor IF (e.g. an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1) can be used to accurately position the patterning device MA with respect to the path of the radiation beam B, e.g. after mechanical retrieval from a mask library, or during a scan. In general, movement of the patterning device support structure MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW.

In the case of a stepper (as opposed to a scanner) the patterning device support structure MT may be connected to a short-stroke actuator only, or may be fixed. Patterning device MA and substrate W may be aligned using patterning device alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the patterning device MA, the patterning device alignment marks may be located between the dies.

The depicted apparatus could be used in at least one of the following modes:

1. In step mode, the patterning device support structure MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the patterning device support structure MT and the substrate table WT are scanned synchronously while a pattern imparted to the radiation beam is projected onto a target portion C (i.e. a single dynamic exposure). The velocity and direction of the substrate table WT relative to the patterning device support structure MT may be determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In another mode, the patterning device support structure MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may be employed.

An immersion lithography solution with a localized liquid supply system is shown in FIG. 4. Liquid is supplied by two groove inlets IN on either side of the projection system PL and is removed by a plurality of discrete outlets OUT arranged radially outwardly of the inlets IN. The inlets IN and outlets OUT can be arranged in a plate with a hole in its center and through which radiation is projected. Liquid is supplied by one groove inlet IN on one side of the projection system PL and removed by a plurality of discrete outlets OUT on the other side of the projection system PL, causing a flow of a thin film of liquid between the projection system PL and the substrate W. The choice of which combination of inlet IN and outlets OUT to use can depend on the direction of movement of the substrate W (the other combination of inlet IN and outlets OUT being inactive).

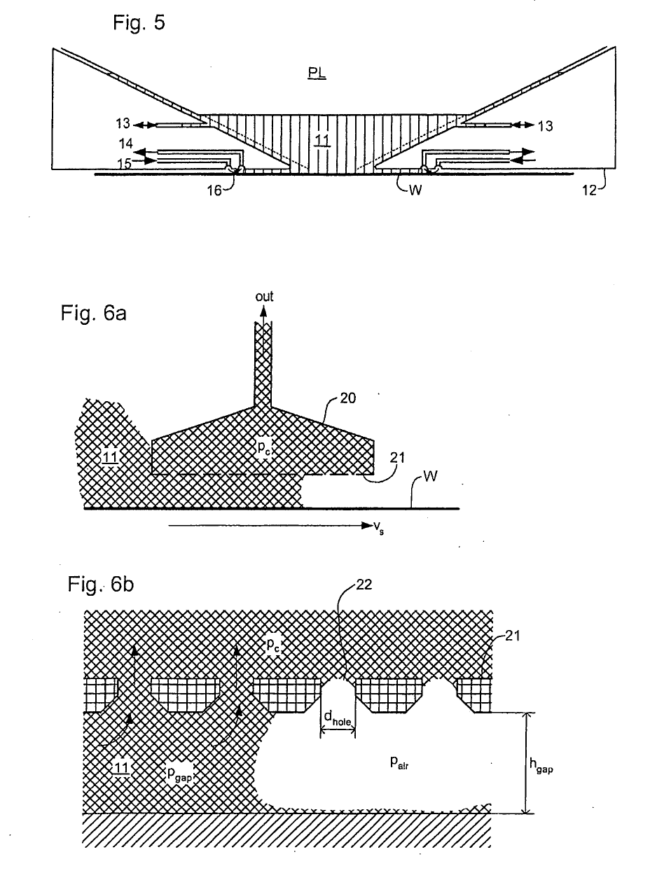

Another immersion lithography solution with a localized liquid supply system solution which has been proposed is to provide the liquid supply system with a liquid confinement structure (sometimes referred to as an immersion hood) which extends along at least a part of a boundary of the space between the final element of the projection system and the substrate table. The liquid confinement structure is substantially stationary relative to the projection system in the XY plane though there may be some relative movement in the Z direction (in the direction of the optical axis). In an embodiment, a seal is formed between the liquid confinement structure and the surface of the substrate. Desirably, the seal is a contactless seal such as a gas seal. Such a system with a gas seal is illustrated in FIG. 5 and is disclosed in United States patent application publication no. US 2004-0207824, hereby incorporated in its entirety by reference.

Referring to FIG. 5, reservoir 11 forms a contactless seal to the substrate around the image field of the projection system so that liquid is confined to fill an immersion space between the substrate surface and the final element of the projection system. The reservoir is at least partly formed by a liquid confinement structure 12. The liquid confinement structure is positioned below the final element of the projection system PL. The liquid confinement structure may surround the final element of the projection system PL. Liquid is brought into the space below the projection system and within the liquid confinement structure 12 through port 13 (and optionally removed by port 13). The liquid confinement structure 12 extends a little above the final element of the projection system. The liquid may rise above the final element. Thus, a buffer of liquid is provided. The liquid confinement structure 12 has an inner periphery that at the upper end, In an embodiment the inner periphery at the upper end closely conforms to the shape of the projection system or the final element thereof and may, e.g., be round. At the bottom, the inner periphery closely conforms to the shape of the image field, e.g., rectangular though this need not be the case.

The liquid is confined in the reservoir by a gas seal 16. The gas seal 16 is located between the bottom of the liquid confinement structure 12 and the surface of the substrate W. The gas seal is formed by gas, e.g. air or synthetic air. In an embodiment, nitrogen or another inert gas, is provided under pressure via inlet 15 to the gap between liquid confinement structure 12 and substrate. The inert gas may be extracted via first outlet 14. The overpressure on the gas inlet 15, vacuum level on the first outlet 14 and geometry of the gap are arranged so that there is a high-velocity gas flow inwards that confines the liquid.

The substrate W may be removed from the substrate table WT, for example, between exposures of different substrates. When this occurs it may be desirable for liquid to be kept within the liquid confinement structure 12. This may be achieved by moving the liquid confinement structure 12 relative to the substrate table WT, or vice versa. Thus the liquid confinement structure is over a surface of the substrate table WT away from the substrate W. Such a surface may be a shutter member. Immersion liquid may be retained in the liquid confinement structure by operating the gas seal 16 or by clamping the surface of the shutter member to the undersurface of the liquid confinement structure 12. The clamping may be achieved by controlling the flow and/or pressure of fluid provided to the undersurface of the liquid confinement structure 12. For example, the pressure of gas supplied from the inlet 15 and/or the under pressure exerted from the first outlet 14 may be controlled.

The shutter member may be an integral part of the substrate table WT or it may be a detachable and/or replaceable component of the substrate table WT. Such a detachable component may be referred to as closing disk or a dummy substrate. In a dual or multi-stage arrangement, the entire substrate table WT is replaced during substrate exchange. In such an arrangement the detachable component may be transferred between substrate tables. The shutter member may be an intermediate table that may be moved adjacent to the substrate table WT, for example, prior to exchange of the substrate under the liquid confinement structure 12. The liquid confinement structure 12 may then be moved over the intermediate table, or vice versa. The intermediate table may be used for cleaning and/or measuring components of the projection system and/or immersion system. The shutter member may be a moveable component of the substrate table, such as a retractable bridge, which may be positioned between substrate tables, for example, during substrate exchange. The surface of the shutter member may be moved under the liquid confinement structure, or vice versa.

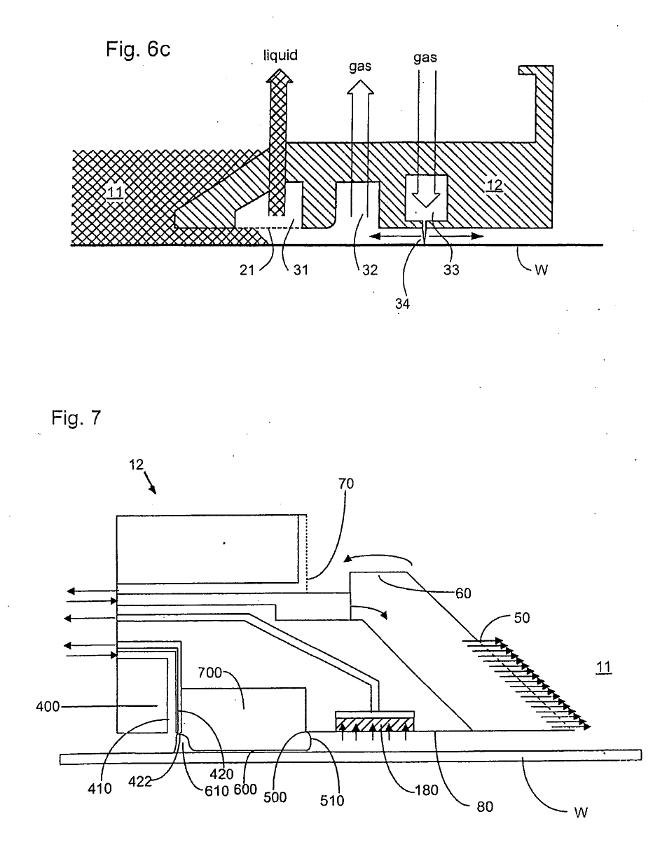

FIGS. 6a and 6b, the latter of which is an enlarged view of part of the former, illustrate a liquid removal device 20 which may be used in an immersion system to remove liquid between the liquid confinement structure IH and the substrate W. The liquid removal device 20 comprises a chamber which is maintained at a slight under pressure pc and is filled with the immersion liquid. The lower surface of the chamber is formed of a porous member 21 having a plurality of small holes, e.g. of diameter dₕₒₗₑ in the range of about 5 μm to about 50 μm. The lower surface may be maintained at a height h_{gap} in the range of about 50 μm to about 300 μm above a surface from which liquid is to be removed, e.g. the surface of a substrate W. The porous member 21 may be a perforated plate or any other suitable structure that is configured to allow the liquid to pass therethrough. In an embodiment, porous member 21 is at least slightly liquidphilic, i.e. having a contact angle of greater than 0°, but less than 90° to the immersion liquid, e.g. water (in which case it would be hydrophilic). Desirably the contact angle is between 75 and 85°.

The under pressure p_{c} is such that the menisci 22 formed in the holes in the porous member 21 prevent gas being drawn into the chamber of the liquid removal device. However, when the porous member 21 comes into contact with liquid on the surface W there is no meniscus to restrict flow. The liquid can flow freely into the chamber of the liquid removal device. Such a device can remove most of the liquid from the surface of a substrate W. However, a thin film of liquid may remain, as shown in the drawings.

To improve or maximize liquid removal, the porous member 21 should be as thin as possible. The pressure differential between the pressure in the liquid p_{gap} and the pressure in the chamber p_{c} should be as high as possible; while the pressure differential between p_{c} and the pressure in the gas in the gap pair should be low enough to prevent a significant amount of gas being drawn into the liquid removal device 20. It may not always be possible to prevent gas being drawn into the liquid removal device. Yet the porous member may prevent large uneven flow that may cause vibration. A micro-sieve made by electroforming, photoetching and/or laser cutting can be used as the porous member 21. A suitable sieve is made by Stork Veco B.V., of Eerbeek, the Netherlands. Other porous plates or solid blocks of porous material may be used, provided the pore or hole size is suitable to maintain a meniscus with the pressure differential that will be experienced in use.

Such liquid removal devices can be incorporated into many types of liquid supply systems and liquid confinement structures. One example is illustrated in FIG. 6c as disclosed in United States Patent Application Publication No. US 2006-0038968. FIG. 6c is a cross-sectional view of one side of the liquid confinement structure 12, which forms a ring (as used herein, a ring may be circular, rectangular or any other shape) at least partially around the exposure field of the projection system (not shown in FIG. 6c). In this embodiment, the liquid removal device is formed by a ring-shaped chamber 31 near the innermost edge of the underside of the liquid confinement structure 12. The lower surface of the chamber 31 is formed by a porous member such as the porous member 21 described above. Ring-shaped chamber 31 is connected to a suitable pump or pumps to remove liquid from the chamber and maintain the desired under pressure. In use, the chamber 31 is full of liquid but is shown empty here for clarity.

Outward of the ring-shaped chamber 31 are a gas extraction ring 32 and a gas supply ring 33. The gas supply ring 33 has a narrow slit in its lower part and is supplied with gas, e.g. air, artificial air or flushing gas. The gas is supplied at a pressure such that the gas escaping out of the slit forms a gas knife 34. The gas forming the gas knife is extracted by a suitable vacuum pump connected to the gas extraction ring 32. So, the resulting gas flow drives any residual liquid inwardly where it can be removed by the liquid removal device and/or a vacuum pump, which should be able to tolerate vapor of the immersion liquid and/or small liquid droplets. However, since the majority of the liquid is removed by the liquid removal device 20, the small amount of liquid removed via the vacuum system should not cause an unstable flow which may lead to vibration.

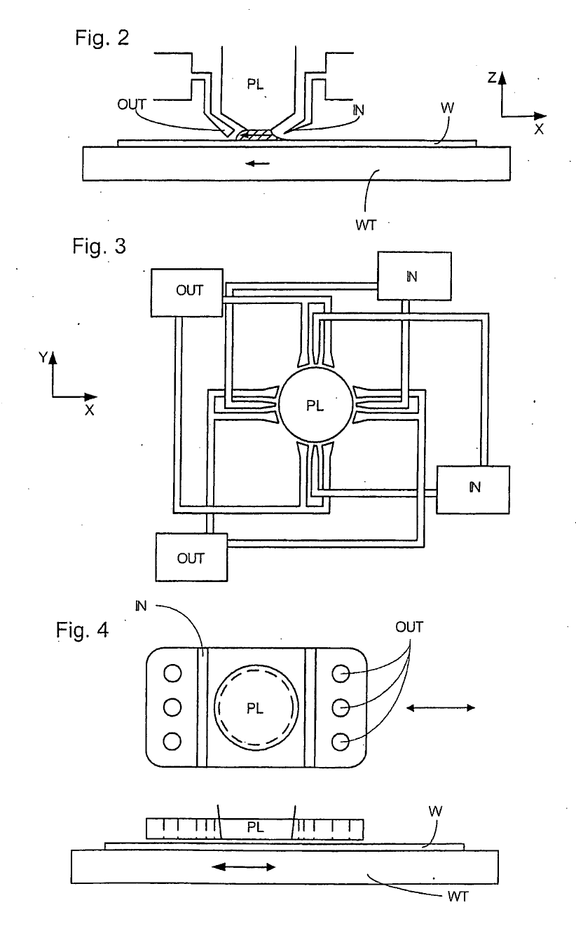

While the chamber 31, gas extraction ring 32, gas supply ring 33 and other rings are described as rings herein, it is not necessary that they surround the exposure field or be complete. In an embodiment, such inlet(s) and outlet(s) may simply be circular, rectangular or other type of elements extending partially along one or more sides of the exposure field, such as for example, shown in FIGS. 2, 3 and 4. They may be continuous or discontinuous.

In the apparatus shown in FIG. 6c, most of the gas that forms the gas knife is extracted via gas extraction ring 32. Some gas may flow into the environment around the liquid confinement structure and potentially disturb the interferometric position measuring system IF. This may be prevented by the provision of an additional gas extraction ring outside the gas knife (not illustrated).

FIG. 7 illustrates, in cross-section, an embodiment of a liquid confinement structure 12 which is part of a liquid supply system LSS. The liquid confinement structure 12 extends around the periphery of the final element of the projection system such that the liquid confinement structure (which may be called a seal member) is, for example, substantially annular in overall shape. The projection system may not be circular and the inner and/or outer edge of the liquid confinement structure 12 may not be circular. Thus, it is not necessary for the liquid confinement structure to be ring shaped and it could be another shape which has a central opening. Through the central opening, the projection beam may pass out of the final element of the projection system through liquid contained in the central opening and onto the substrate W. The function of the liquid confinement structure 12 is to at least partly maintain or confine liquid in the space between the projection system and the substrate W so that the projection beam may pass through the liquid.

The liquid confinement structure 12 comprises a plurality of inlets 50 through which liquid is provided into the space between the final element of the projection system and the substrate W. Liquid may flow over the protrusion 60 and then be extracted through extractor 70. This arrangement can substantially prevent overflowing of the liquid over the top of the liquid confinement structure 12. The top level of the liquid is simply contained by the presence of the liquid confinement structure 12. The level of liquid in the space is maintained such that the liquid does not overflow over the top of the liquid confinement structure 12.

A seal is provided between the bottom of the liquid confinement structure 12 and the substrate W. In FIG. 7, the seal is a contactless seal. A device to provide the seal is made up of several components. Working radially outwardly from the optical axis of the projection system along the bottom 80 of the liquid confinement structure 12 there is provided a single phase extractor 180 such as the one disclosed in United States patent application publication no. US 2006-0038968, incorporated herein in its entirety by reference. Any type of liquid extractor can be used. In an embodiment, the liquid extractor comprises an inlet which is covered in a porous material. The porous material is used to separate liquid from gas to enable single-phase liquid extraction. Radially outwardly of the single-phase extractor 180 is a meniscus pinning feature 500. In the case of the embodiment illustrated in FIG. 7, the meniscus pinning feature is a sharp corner though other meniscus pinning features may be used. This meniscus pinning feature 500 pins a meniscus of liquid 510 at that position. However, a film of liquid 600 is still likely to remain on the surface of the substrate W.

A recess 700 is provided in the bottom surface of the liquid confinement structure 12. The recess enables the film of liquid 600 to not be constrained and have a free top surface. Radially outwardly of the recess 700 is a gas knife and liquid extractor assembly 400 which will be described in more detail below. An embodiment of the present invention is directed to the gas knife and liquid extractor assembly and can be used with any liquid supply system, including those illustrated in FIGS. 2-6c. In particular, the gas knife and liquid extractor assembly may be used with those types of liquid supply system which provide liquid to a localized area of the substrate (i.e. those which provide liquid to a top surface area of the substrate W smaller, in plan, than the overall top surface area of the substrate W and relative to which the substrate W is moved). The gas knife and liquid extractor assembly 400 can form part of the liquid supply system as illustrated in FIG. 7 or can be separate from the remainder of the liquid supply system. The single phase extractor 180 and meniscus pinning feature 500 of the FIG. 7 embodiment could be replaced with any other type of (partial) seal.

The gas knife assembly 400 comprises a gas knife 410. The gas knife 410 extends around the entire periphery of the liquid confinement structure 12 thereby surrounding the space 11. This is not necessarily the case and there may be areas at which the gas knife 410 is not continuous. Radially inwardly of the gas knife 410 in the cross-section in FIG. 7 is a liquid extractor 420.

The liquid extractor 420 may not be positioned peripherally around the entire space occupied by liquid. The liquid extractor 420 may only be positioned at discrete locations. Indeed, the liquid extractor 420 may be comprised of several individual discrete liquid extractors positioned at places along the (peripheral) length of the gas knife 410. The locations at which the liquid extractor 420 is positioned can be regarded as stagnation points. A stagnation point is at point at which liquid which is moving away from the optical axis of the apparatus (along which the projection beam propagates) is concentrated by the shape of the gas knife 410.

As can be seen from FIG. 7, the effect of the gas knife is to create a build-up of liquid 610 just radially inwardly of the gas knife 410. A fast jet of gas is directed by the gas knife 410 in a direction substantially perpendicular to the top surface of the substrate W. The gas knife 410 is designed to move this build-up of liquid, in combination with the moving substrate W, to one of the so called stagnation points at which a liquid removal device 420 will be able efficiently to remove the build-up of liquid 610.

The maximum speed at which the substrate W may move under the projection system and/or the liquid confinement structure 12 is determined at least in part by the speed at which the build-up of liquid 610 breaks through the gas knife. Thus, this build-up of liquid should be removed before its pressure becomes great enough to force its way past the gas knife 410. This is achieved in an embodiment of the present invention by ensuring that the build-up of liquid is moved along the gas knife to an extraction point. This allows the liquid extractor 420 to operate efficiently because the build-up of liquid will completely or substantially cover its end or inlet 422 such that the extractor extracts exclusively or substantially liquid rather than a mixture of liquid and gas. In the mode of operation where substantially only liquid is extracted the efficiency of the extractor is increased.

The above mentioned single phase extractors (as well as other types) can be used in a liquid supply system which supplies liquid to only a localized area of the top surface of the substrate. Furthermore, such a single phase extractor can be used in other types of immersion apparatus. For example, single phase extractors can be used in a bath type immersion lithographic apparatus. In the bath type immersion lithographic apparatus the whole of the top surface of the substrate is covered in liquid. The extractors may be used for an immersion liquid other than water. The extractors may be used in a so-called “leaky seal” liquid supply system. In such a liquid supply system, liquid is provided to the space between the final element of the projection system and the substrate. That liquid is allowed to leak from that space radially outwardly. For example, a liquid supply system is used which does not form a seal between itself and the top surface of the substrate or substrate table, as the case may be. The immersion liquid may only be retrieved radially outwardly of the substrate in a “leaky seal” apparatus.

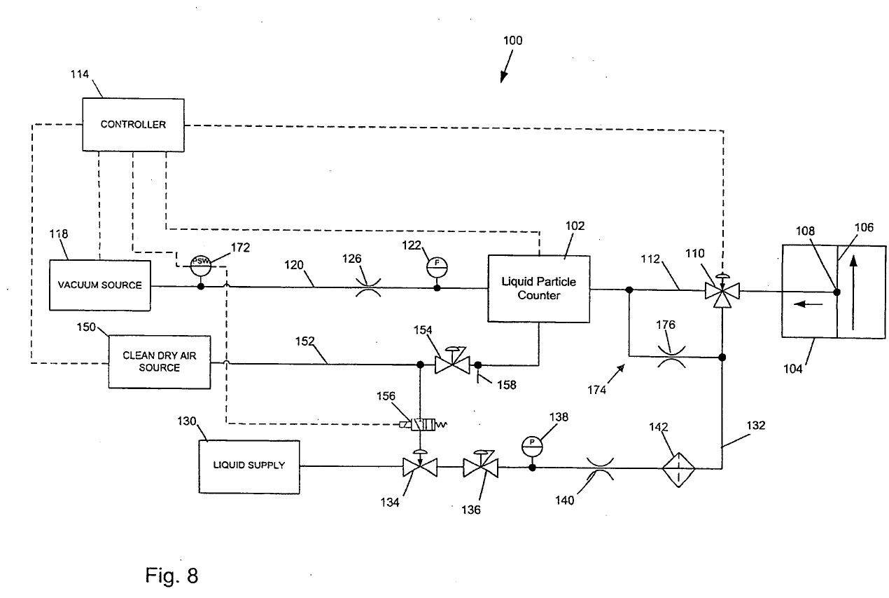

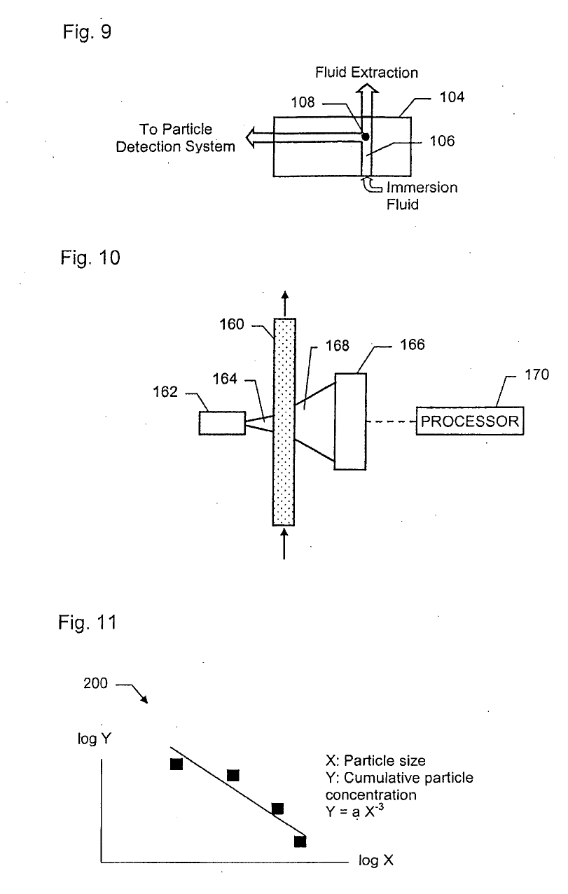

FIG. 8 schematically illustrates a particle detection system 100 according to an embodiment of the present invention. As shown in FIG. 8, the particle detection system 100 includes a liquid particle counter 102. The particle counter 100 is connected to a liquid confinement structure 104, i.e. a fluid handling structure, of an immersion lithographic apparatus. The liquid confinement structure 104 may be any of the types described above and their variations. Specifically, a single phase extractor 106 of the liquid confinement structure 104 is connected to the liquid particle counter 102 such that a small sample of immersion liquid may be extracted directly out of a sample location 108. The sample location 108 is located in the single phase liquid extractor 106, as shown in FIG. 9. (Note that although a single phase extractor is mentioned here and in the following description, the extractor may be a two phase extractor which extracts both gas and liquid. If the extractor is a two phase extractor, the two phases are later separated prior to arrival of the fluid at the sample point 108. Thus a sample is taken from a single phase, namely liquid. Reference herein to a single phase extractor includes reference to this other arrangement). By locating the sample point 108 for the small sample of immersion liquid that has flowed over potentially contaminated surfaces inside of the liquid confinement structure 104 such that all extracted flow is single phase, contamination particles may be detected. The sample may be analyzed for example for: particle content and/or, a change in particle content over time, especially an increase in particle content, as discussed in further detail below.

As illustrated in FIG. 8, a three-way valve 110 may be positioned in a conduit 112 that connects the sample point 108 in the liquid phase extractor 106 to the liquid particle counter 102. Operation of the three-way valve 110 may be controlled by a controller 114, as discussed in further detail below. The controller 114 may comprise a processor. The processor may run one or more computer programs. Threshold values and/or measured data may be stored on a memory associated with the controller.

The immersion fluid may be extracted from the sample location 108 in the liquid confinement structure 104 by a vacuum system. The vacuum system includes a vacuum source 118. The vacuum source is configured to provide an under pressure in a conduit 120. The conduit 120 is positioned between the vacuum source 118 and the liquid particle counter 102, the liquid particle counter 102, and the conduit 112. So on application of an under pressure in the conduit 120, a sample may be extracted from the sample location 108. Because the vacuum system is configured to handle liquid, the vacuum system may be considered to be a wet vacuum system.

In an embodiment, the vacuum system may be configured to provide an under pressure selected from about −10 kPa to about −90 kPa. In an embodiment, the vacuum system may be configured to provide an under pressure of about −50 kPa. The vacuum system may include a flow sensor 122, which may be located upstream or downstream of the liquid particle counter 102 relative to the liquid confinement structure 104. The extracted flow rate of the sample from the liquid confinement structure 104 may be regulated with a flow restrictor 126 located between the liquid particle counter 102 and the vacuum source 118. The extracted flow may be monitored with the flow sensor 122.

As illustrated in FIG. 8, the flow sensor 122 is located downstream of the liquid particle counter 102 relative to the liquid confinement structure 104. In case of a measured flow rate that falls outside a certain operating range, a signal may be generated and communicated to the controller 114. The signal may indicate that the particle count values being generated by the liquid particle counter 102 may not be reliable, due to an incorrect flow rate through the liquid particle counter 102.

The particle detection system 100 includes a liquid supply 130 that is connected to the three-way valve 110 via a conduit 132. As illustrated in FIG. 8, one or more of a control valve 134, a pressure regulator 136, a pressure sensor 138, a flow restrictor 140, and a filter 142 may be positioned in the conduit 132. This arrangement may allow for control of the liquid that flows from the liquid supply 130 to the valve 110 in terms of pressure and flow rate. In addition, the filter 142 allows the liquid from the liquid supply 130 to be filtered prior to entering the valve 110 and the liquid particle counter 102. The control valve 134 may be in communication with the controller 114 so that the controller 114 may send signals to the control valve 134. The signals may cause the control valve 134 to open and close, as discussed in further detail below.

A source of clean dry air (CDA) 150 may be connected to the liquid particle counter 102 via a conduit 152. The conduit 152 may include a pressure regulator 154 that is configured to regulate the pressure of the air being supplied to the liquid particle counter 102. The clean dry air may be provided to a pneumatic control device 156. The control device 156 is connected to and controlled by the controller 114. The control device 156 is configured to control operation of the control valve 134 in the conduit 132 that provides liquid from the liquid supply 130 to the three-way valve 110. A pressure gauge (not shown) may be connected to a sample point 158 so that the pressure regulator 154 may be adjusted.

A schematic of the liquid particle counter 102 is shown in FIG. 10. Because liquid particle counters are known, such as the liquid particle counter described in United States Patent Application Publication No. 2006/0038998, which is incorporated herein by reference in its entirety by reference, the details of the liquid particle counter 102 are not provided. As shown in FIG. 10, the liquid particle counter 102 includes a sample holder 160 through which liquid entering the liquid particle counter 102 flows. The sample holder 160 may be in the form of a capillary tube.

A laser 162 is configured to provide a laser beam 164 that radiates a portion of the liquid in the sample holder 160. When the laser beam 164 hits a particle in the liquid, light is scattered due to a difference in refractive index between the particle and the liquid carrying the particle. However, gases, such as air, have (large) differences in refractive indices with liquids, which is why gas bubbles may be falsely reported as particles in a conventional liquid particle counter. Therefore, it is desirable to differentiate solid particles from gaseous particles (i.e. gas bubbles) in a liquid particle counter.

A light detector 166, such as a dark-field light detector, is configured to detect any stray light that is radiated because of scattering. The detector 166 provides a signal to a processor 170 that is indicative of the scattered light. The processor 170 is configured to compare the magnitude of the signal from the detector 166 to a calibration curve. An example of such a calibration curve 200 is illustrated in FIG. 11. The processor 170 may then translate a peak of the signal into particle sizing information. Particles of certain sizes are then classified and put into so-called size bins by the processor 170. Such a classification technique is known and is therefore not discussed in greater detail herein.

In a non-filtered system of, for example, ultra pure water, the ratio of the number of particles between such bins is predictable. As illustrated in FIG. 11, a cumulative particle concentration Y is proportional to the particle size X to the power −3. For a given immersion liquid that contains particles, a calibration curve like the one illustrated in FIG. 11 may be generated and used to determine whether a sample of the immersion liquid that has been extracted from the liquid confinement structure contains particles.

Returning to FIG. 10, the detector 166 in the liquid particle counter 102 generates a noise level. The value of this noise level may be expressed as the so-called DC light level. This property may be used in different ways. If the DC light level is too low, the laser 162 in the liquid particle counter 102 may be near the end of its life, which may cause a weaker beam. This may be the case if optics within the liquid particle counter 102 are misaligned. Additionally or in the alternative, if the optics and/or sample holder 160 within the liquid particle counter 102 is polluted or somewhat misaligned, the DC light level may become too high. If the sample holder 160 is filled with a two-phase flow (i.e., liquid and gas) or entirely with a gas, the DC light level may increase.

The processor 170 may be configured to compare a so-called “normal” DC light level. “Normal” DC light level is indicative of the liquid particle counter 102 operating within typical specifications. While detecting the DC light level during operation it is possible to determine whether the liquid particle counter 102 is operating properly. If an abnormality is detected, the processor 170 may provide a signal to the controller 114 that indicates that the liquid particle counter 102 may need to be recalibrated.

As discussed above, the difference between refractive index of a gas bubble and liquid, especially water, is very large. Therefore, upon detection, a gas bubble is generally classified as a larger particle, i.e. in a size bin for a larger particle. The size bins may be defined by ranges of diameters, as is commonly used in the art, although other parameters, such as radii, cross-sectional areas, etc., may be used. The detection of a gas bubble causes the count ratio between bins for different sized particles to change relative to the calibration curve. This aspect can be used to validate presence (or absence) of gas bubbles in the liquid passing through the liquid particle detector 102.

Specifically, the count ratios of specific size bins may be significantly different from the calibration curve. This may occur because there are more particles in the size bins for larger particle due to the presence of a gas bubble. If a count ratio is specifically different from the calibration curve, the collected data will no longer fit the calibration curve, such as the curve illustrated in FIG. 11. A higher than normal signal of the DC light level may provide a stronger indication that the data does not fit the calibration curve. By being able to verify that there are no gas bubbles in the sample of the immersion liquid from the liquid confinement structure 104, the signal from the liquid particle counter 102 may be used to monitor whether the immersion liquid can be considered clean (e.g. below a certain threshold of particle counts and/or a specific distribution of particle counts across the different size bins) and the extent or degree of cleanliness of the immersion liquid.

By being able to monitor the cleanliness of the immersion liquid, and therefore the cleanliness of surfaces that have come into contact with the immersion liquid, major process excursions may be detected more quickly and/or corrective action may be taken earlier. A corrective measure could be (in a non-limiting list) one of changing a component of a system preparing (i.e. purifying) and supplying the liquid, and initiating a cleaning routine of a part of the immersion system. Detecting process excursions more quickly may reduce the number of defective substrates processed by the immersion lithography apparatus, and the defect count density (i.e. defectivity) of an exposed substrate.

Upon detection of increased particle counts, desirably along with the verification that the detected particles are solid particles (i.e., contamination) and not gas bubbles, lot operation of the apparatus may be aborted or another corrective step may be taken. A signal may be initiated. Embodiments of the invention may be used for long-term trend analysis of solid particle (contamination) counts. The trend analysis may provide information to the controller 114 to determine when the signal should be initiated. The signal may be directed to an operator so that the operator may be informed that a major process excursion has occurred or another corrective measure has been taken.

For example, it may be desirable to clean the liquid containment structure or any other part of the lithographic apparatus that has come into contact with the immersion fluid. A cleaning action, such as an in-line, off-line, or any other type of cleaning action may be used to clean contaminants within the apparatus that are the result of normal production. Alternatively or additionally, it may be desirable to replace one or more parts of the liquid containment structure, such as the porous member 21 described above. Other methods of mitigation may be alternatively or additionally used, such as changing one or more operating conditions (e.g. increase under pressure in the liquid extractor 106 or reduce scanning speed), and the examples provided should not be considered to be limiting in any way. It may also be desirable to take no action. In the case of a major process excursion, for example, within 10 minutes of the occurrence of the event, production may be stopped. Production of damaged substrates may be prevented. The effect of the process excursion on total output of the system may be limited.

Returning to FIG. 8, the liquid particle counter 102 may be arranged in such a way that the immersion liquid may be extracted out of the liquid confinement structure 104 during wet operation of the immersion lithography apparatus. During dry operation of the immersion lithography apparatus, a second liquid, i.e., a liquid that is not the immersion liquid, may be fed to the liquid particle counter 102 by the liquid supply 130. This is to keep the liquid particle counter 102 well-conditioned during dry operation. By keeping the liquid particle counter 102 constantly wet, the opportunity for false readings may be minimized. The start-up time for the liquid particle counter 102 may be substantially reduced or even eliminated.

Specifically, when the controller 114 receives a signal indicating that the immersion lithography apparatus is about to be switched from wet operation to dry operation, the controller 114 may signal the three-way valve 110 to redirect the flow therethrough. The valve 110 may be switched to block the flow of the immersion liquid from the liquid confinement structure 104 from entering the valve 110. The switching of the valve 110 may allow the flow of the liquid flowing through the conduit 132 from the liquid supply 130 through the valve 110. In this way, the liquid which may be supplied by the liquid supply 130 is provided to the liquid particle counter 102 rather than immersion liquid. The controller 114 is also configured to control the valve 110 so that if a flow of the immersion liquid is below a certain threshold value, the valve 110 may allow the liquid from the liquid supply 110 to flow to the particle counter 102. The certain threshold value may be based on a desirable flow to the liquid particle counter 102 so that the liquid particle counter 102 may operate properly. The flow of liquid from the liquid supply 130 may be in addition to the flow of the immersion liquid.

If there is a disruption in the vacuum from the vacuum system 116, there may be a risk of liquid flowing towards the liquid confinement structure 104 instead of liquid flowing away from the liquid confinement structure 104. To substantially reduce or eliminate this risk, a pressure switch 172 is present in the vacuum line. If the pressure switch 172 detects the absence of a vacuum, the switch 172 may disable the pneumatic control device 156 that controls the control valve 134 in the conduit 132 from the liquid supply 130. Then, the liquid being supplied from the liquid supply 130 cannot flow towards the liquid confinement structure 104.

In an embodiment, a bypass 174 may be provided. The bypass 174 may be configured to allow liquid supplied by the liquid supply 130 to bypass the three-way valve 110. As illustrated in FIG. 8, the bypass 174 includes a flow restrictor 176. The flow restrictor 176 is configured to restrict the flow rate of the liquid to a certain rate. The bypass 174 may be configured to provide a supplemental flow of liquid to the liquid particle counter 102 in addition to the flow of the immersion liquid to the liquid particle counter 102, in case the flow from the liquid confinement structure 104 is insufficient. Such an arrangement may allow the liquid particle counter 102 to operate continuously, as discussed above.

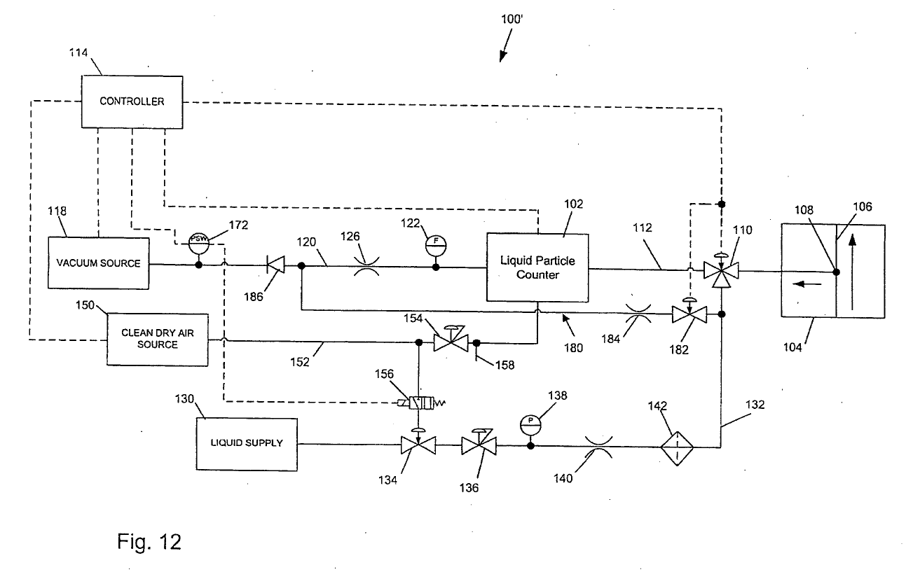

FIG. 12 illustrates a particle detection system 100′ according to an embodiment of the invention. The particle detection system 100′ includes many of the features described above with reference the particle detection system 100 of FIG. 8. Instead of, or in addition to the bypass 174 illustrated in FIG. 8, the particle detection system 100′ includes a bypass 180. The bypass 180 is constructed and arranged to allow liquid from the liquid supply 130 to bypass the liquid particle counter 102. The bypass 180 may be used to keep the flow of the liquid in the particle detection system 100′ stable and to keep the level of contamination as low as possible. By having a continuous flow of liquid from the liquid supply 130, stagnation of the liquid, which may cause the liquid to be contaminated, within the particle detection system 100′ may be minimized or even prevented.

The bypass 180 includes a valve 182 that may be controlled by the controller 114. The controller 114 may be programmed to determine whether the bypass 180 should be used, based on for example the signal provided by the flow sensor 122. The bypass 180 may also include a flow restrictor 184 that may be configured to restrict the flow of the liquid in the bypass 180 to a predetermined flow. As illustrated in FIG. 12, a check valve 186 may be positioned in the conduit 120 between the vacuum source 118 and the junction between the bypass 180 and the conduit 120. The check valve 186 may prevent any water that has contamination particles that is in the vacuum system from reaching the liquid particle counter 102 in case the vacuum system accidentally has an overpressure.

In an embodiment, a method of operating a liquid particle counter for an immersion lithographic apparatus that includes a projection system, a substrate table, and a fluid handling structure, includes flowing a sample through the liquid particle counter, wherein the sample comprises a first liquid from the fluid handling structure when the fluid handling structure is confining liquid between the projection system and a substrate being supported by the substrate table and/or the substrate table, or a second liquid from a liquid supply when the fluid handling structure is not confining liquid between the projection system and the substrate being supported by the substrate table and/or substrate table; and detecting particles in the sample. In an embodiment the method may include identifying which of the detected particles in the sample are solid particles; and initiating a signal if the detected solid particles are above a certain threshold. In an embodiment, the method may include initiating a cleaning operation in response to the signal. In an embodiment, the method may include shutting down the lithographic apparatus in response to the signal. In an embodiment, the detecting may include directing a beam of radiation through the sample and detecting radiation scattered by the particles. In an embodiment, the identifying may include isolating a signal representative of gas bubbles so that a remaining signal represents the solid particles.

In an embodiment, the lithographic apparatus may include a substrate support configured to hold a substrate; a projection system configured to project a patterned beam of radiation onto a target portion of the substrate; a fluid handling structure configured to supply an immersion fluid to a space between the projection system and the substrate and/or the substrate support, and an opening through which the immersion fluid is extracted from the space; a particle counter connected to the opening, the particle counter configured to detect particles in a sample provided to the particle counter; and a liquid supply configured to supply a liquid to the particle counter when a flow of the immersion fluid is below a certain threshold value. In an embodiment, the lithographic apparatus may include a valve located 1) in between the outlet of the fluid handling structure and the particle counter, and 2) in between the liquid supply and the particle counter, wherein the valve is configured to be switched so that the sample provided to the particle counter is from the immersion fluid when the immersion fluid is extracted from the space, and from the liquid supply when the immersion fluid is not extracted from the space. In an embodiment, the lithographic apparatus may include a controller configured to control the valve so that if the flow of the immersion fluid is below the certain threshold value, the valve allows the liquid from the liquid supply to flow to the particle counter. In an embodiment, the lithographic apparatus may include a particle counter that is configured to a isolate signal indicative of gas bubbles so that a remaining signal can be analyzed to identify the solid particles. In an embodiment, the lithographic apparatus may include an illumination system configured to condition a beam of radiation; and a support configured to support a patterning device, the patterning device being configured to pattern the beam of radiation.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g. having a wavelength of or about 365, 248, 193, 157 or 126 nm).

The term “lens”, where the context allows, may refer to any one or combination of various types of optical components, including refractive and reflective optical components.

While specific embodiments of the invention have been described above, it will be appreciated that the invention may be practiced otherwise than as described. For example, the embodiments of the invention may take the form of a computer program containing one or more sequences of machine-readable instructions describing a method as disclosed above, or a data storage medium (e.g. semiconductor memory, magnetic or optical disk) having such a computer program stored therein. Further, the machine readable instruction may be embodied in two or more computer programs. The two or more computer programs may be stored on one or more different memories and/or data storage media.

The controllers described above may have any suitable configuration for receiving, processing, and sending signals. For example, each controller may include one or more processors for executing the computer programs that include machine-readable instructions for the methods described above. The controllers may also include data storage medium for storing such computer programs, and/or hardware to receive such medium.

One or more embodiments of the invention may be applied to any immersion lithography apparatus, in particular, but not exclusively, those types mentioned above and whether the immersion liquid is provided in the form of a bath, only on a localized surface area of the substrate, or is unconfined. In an unconfined arrangement, the immersion liquid may flow over the surface of the substrate and/or substrate table so that substantially the entire uncovered surface of the substrate table and/or substrate is wetted. In such an unconfined immersion system, the liquid supply system may not confine the immersion liquid or it may provide a proportion of immersion liquid confinement, but not substantially complete confinement of the immersion liquid.

A liquid supply system as contemplated herein should be broadly construed. In certain embodiments, it may be a mechanism or combination of structures that provides a liquid to a space between the projection system and the substrate and/or substrate table. It may comprise a combination of one or more structures, one or more liquid inlets, one or more gas inlets, one or more gas outlets, and/or one or more liquid outlets that provide liquid to the space. In an embodiment, a surface of the space may be a portion of the substrate and/or substrate table, or a surface of the space may completely cover a surface of the substrate and/or substrate table, or the space may envelop the substrate and/or substrate table. The liquid supply system may optionally further include one or more elements to control the position, quantity, quality, shape, flow rate or any other features of the liquid.

The descriptions above are intended to be illustrative, not limiting. Thus, it will be apparent to one skilled in the art that modifications may be made to the invention as described without departing from the scope of the claims set out below.

What is claimed is:

1. A method of detecting particles in an immersion fluid of or from a lithographic apparatus, the method comprising:
extracting a sample, using a vacuum system, from a single phase flow of the immersion fluid of or from a fluid handling structure in the lithographic apparatus;
detecting particles in the sample; and
initiating a signal if the detected particles are above a certain threshold.

2. The method according to claim 1, further comprising identifying which of the detected particles in the sample are solid particles.

3. The method according to claim 2, wherein said identifying comprises isolating a signal representative of gas bubbles so that a remaining signal represents the solid particles.

4. The method according to claim 1, wherein the sample is extracted from a location inside of the fluid handling structure.

5. The method according to claim 1, further comprising flowing the immersion fluid over a potentially contaminated surface within the lithographic apparatus prior to extracting the sample.

6. The method according to claim 1, wherein said detecting comprises directing a beam of radiation through the sample and detecting radiation scattered by the particles.

7. The method according to claim 1, wherein the vacuum system provides an under pressure selected from about −10 kPa to about −90 kPa.

8. The method according to claim 7, wherein the vacuum system provides an under pressure of about −50 kPa.

9. The method according to claim 1, wherein the vacuum system is a wet vacuum system.

10. The method according to claim 1, further comprising initiating a cleaning operation in the lithographic apparatus in response to the signal.

11. The method according to claim 1, further comprising shutting down the lithographic apparatus in response to the signal.

12. A lithographic apparatus comprising:
a substrate support configured to hold a substrate;
a projection system configured to project a patterned beam of radiation onto a target portion of the substrate;
a fluid handling structure configured to supply an immersion fluid to a space between the projection system and the substrate and/or the substrate support, and to extract the immersion fluid from the space through an opening of the fluid handling structure;
a vacuum system configured to extract a sample of the immersion fluid from the opening; and
a particle counter located between the vacuum system and the opening, the particle counter configured to detect particles in the sample of the immersion fluid.

13. The lithographic apparatus according to claim 12, further comprising a liquid supply constructed and arranged to supply a liquid, and a valve located 1) in between the opening of the fluid handling structure and the particle counter, and 2) in between the liquid supply and the particle counter so that a sample of the immersion fluid and the liquid from the liquid supply flow can through the valve.

14. The lithographic apparatus according to claim 13, further comprising a controller configured to control the valve so that if a flow of the immersion fluid is below a certain threshold value, the valve allows the liquid from the liquid supply to flow to the particle counter.

15. The lithographic apparatus according to claim 12, wherein the fluid handling structure comprises an inlet through which the immersion fluid is supplied to the space.

16. The lithographic apparatus according to claim 12, wherein the opening is an outlet through which the immersion fluid is extracted from the space.

17. The lithographic apparatus according to claim 12, wherein the particle counter is configured to isolate a signal indicative of gas bubbles so that a remaining signal can be analyzed to identify solid particles.

18. The lithographic apparatus according to claim 12, further comprising:
an illumination system configured to condition a beam of radiation; and
a support configured to support a patterning device, the patterning device being configured to pattern the beam of radiation.
